(19) United States
(12) Patent Application Publication
(10) Pub. No.: US 2016/0138934 A1
(43) Pub. Date: May 19, 2016

(54) VEHICLE AND CONTROL METHOD THEREOF

(71) Applicant: Hyundai Motor Company, Seoul (KR)

(72) Inventor: Jeong Hun Kim, Seongnam (KR)

(21) Appl. No.: 14/852,522

(22) Filed: Sep. 12, 2015

(30) Foreign Application Priority Data
Nov. 17, 2014 (KR) 10-2014-0160306

(51) Int. Cl. G01C 21/36

(52) U.S. Cl. CPC G01C 21/3697; G01C 21/3691

(57) ABSTRACT

A vehicle is provided that more efficiently responds to a change of driving regulations. The vehicle includes a communication unit that is configured to communicate with a regulations management apparatus that manages regulations information for individual regions. A navigation system is configured to receive location information of the vehicle and display a location of the vehicle on a map output on a display. In addition, a controller is configured to predict an expected driving region of the vehicle based on the location information of the vehicle and to download regulations information of the expected driving region from the regulations management apparatus when regulations information of the expected driving region has been updated.

### CROSS-REFERENCE TO RELATED APPLICATION

This application claims the benefit of Korean Patent Application No. 2014-0160306, filed on Nov. 17, 2014 in the Korean Intellectual Property Office, the disclosure of which is incorporated herein by reference.

### BACKGROUND

1. Field

The present disclosure relates to a vehicle and a control method thereof and more particularly, to a vehicle and control method thereof capable of more efficiently responding to a change of regulations.

2. Description of the Related Art

In general, a vehicle is transport means that travels on a road or a track to transport humans or objects to desired places. The vehicle moves by the movement of one or more wheels mounted on the vehicle body. Examples of vehicles include a three-wheeled vehicle, a four-wheeled vehicle, a two-wheeled vehicle such as a motorcycle, a motor bicycle, construction equipment, a bicycle, and a train running on a track.

With wide propagation of vehicles, different traffic regulations have been applied according to regions (e.g., countries or administrative districts). For example, some countries require headlamps to be lit during the daytime. When traveling over many regions, a driver should observe all regulations of the individual regions. However, since there are unnecessary regulations that may increase maintenance, management, and repair costs of the vehicle, an appropriate level of response to regulations is required. Additionally, since regulations may change after the vehicle is released, continuous monitoring on revisions of regulations is required.

### SUMMARY

Therefore, it is an aspect of the present disclosure to provide a vehicle capable of more efficiently responding to a change of regulations, and a control method of the vehicle. Additional aspects of the disclosure will be set forth in part in the description which follows and, in part, will be obvious from the description, or may be learned by practice of the disclosure.

In accordance with one aspect of the present disclosure, a vehicle may include: a communication unit configured to communicate with a regulations management apparatus that manages regulations information for individual regions; a navigation system configured to receive location information of the vehicle, and to display a location of the vehicle on a map output on a display; and a controller configured to predict an expected driving region of the vehicle based on the location information of the vehicle, and to download regulations information of the expected driving region from the regulations management apparatus, when regulations information of the expected driving region has been updated.

The regions may be classified according to administrative districts or the identity of regulations information. The regulations information may include at least one regulation item that a driver is required to observe or is recommended to observe when driving the vehicle. The controller may be configured to download the regulations information for each regulation item. The controller may further be configured to monitor whether the vehicle enters the expected driving region, and manage driving of the vehicle according to the downloaded regulations information when the vehicle enters the expected driving region. The controller may then be configured to change settings of the vehicle or install software in the vehicle, based on the downloaded regulations information.

The navigation system may include a display unit configured to display a changed item of the regulations information when the vehicle enters the expected driving region. The controller may be configured to detect the expected driving region based on a driving history of the vehicle. In particular, the controller may be configured to detect, as the expected driving region, a region within a predetermined distance from the vehicle among one or more regions adjacent to a current driving region of the vehicle.

Furthermore, the controller may be configured to detect the expected driving region based on a driving route to arrive at a destination, the driving route determined by the navigation system. The controller may be configured to detect at least one region included in the driving route as the expected driving region. In addition, the controller may be configured to manage an update history to determine whether the regulations information has been updated. The update history may include at least one of a version of regulations information and an update time of regulations information for each region. The regulations management apparatus may be a telematics server.

In accordance with another aspect of the present disclosure, a control method of a vehicle, the vehicle communicating with a regulations management apparatus that manages regulations information for individual regions, may include: predicting an expected driving region based on location information of the vehicle; and downloading regulations information of the expected driving region from the regulations management apparatus, when regulations information of the expected driving region has been updated.

The control method may further include managing driving of the vehicle according to the downloaded regulations information, when the vehicle enters the expected driving region. The management of the driving of the vehicle may include installing software according to the downloaded regulations information. In addition, the management of the driving of the vehicle may include changing settings of the vehicle according to the downloaded regulations information and displaying a changed item of the regulations information when the vehicle enters the expected driving region.

The predicting of the expected driving region may include determining the expected driving region based on a driving history of the vehicle and determining, as the expected driving region, a region that is within a predetermined distance from the vehicle among one or more regions adjacent to a current driving region of the vehicle. Additionally, the predicting of the expected driving region may include: detecting a driving route to arrive at a destination, the driving route determining by the navigation system; and determining the expected driving region based on the driving route.

The downloading of the regulations information of the expected driving region may include: downloading an updated item of the regulations information from the regulations management apparatus; updating regulations information of the vehicle based on the downloaded item; and storing a history of the updated regulations information in the vehicle.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is an exemplary view of a vehicle system according to an exemplary embodiment of the present disclosure;

FIG. 2 shows the interior of a vehicle system according to an exemplary embodiment of the present disclosure;

FIG. 3 is an exemplary control block diagram of a regulations management apparatus included in a vehicle system according to an exemplary embodiment of the present disclosure;

FIG. 4 is an exemplary view for describing region classification that is performed by a vehicle system according to an exemplary embodiment of the present disclosure;

FIG. 5 is an exemplary view for describing regulations information database included in a vehicle system according to an exemplary embodiment of the present disclosure;

FIG. 6 is an exemplary control block diagram of a vehicle according to an exemplary embodiment of the present disclosure;

FIG. 7 is an exemplary view for describing vehicle route prediction according to an exemplary embodiment of the present disclosure;

FIG. 8 is an exemplary view for describing vehicle route prediction according to another exemplary embodiment of the present disclosure;

FIG. 9 shows an exemplary navigation screen displayed when regulations information is being downloaded according to an exemplary embodiment of the present disclosure;

FIG. 10 shows an exemplary navigation screen for receiving a download start command to download regulations information according to an exemplary embodiment of the present disclosure;

FIG. 11 shows exemplary navigation screen for receiving a download start command to download regulations information according to another exemplary embodiment of the present disclosure;

FIG. 12 shows an exemplary navigation screen that is displayed when a vehicle enters a region to which different regulations are applied according to an exemplary embodiment of the present disclosure;

FIG. 13 shows an exemplary vehicle system according to another exemplary embodiment of the present disclosure;

FIG. 14 shows an exemplary vehicle system according to still another exemplary embodiment of the present disclosure;

FIG. 15 is an exemplary flowchart illustrating a control method of a vehicle, according to an exemplary embodiment of the present disclosure;

FIG. 16 is an exemplary flowchart illustrating operation of predicting a driving region in the control method of FIG. 15, according to an exemplary embodiment of the present disclosure;

FIG. 17 is an exemplary flowchart illustrating operation of predicting a driving region in the control method of FIG. 15, according to another exemplary embodiment of the present disclosure;

FIG. 18 is an exemplary flowchart illustrating operation of updating regulations information in the control method of FIG. 15, according to an exemplary embodiment of the present disclosure; and

FIG. 19 is an exemplary flowchart illustrating operation of controlling driving in the control method of FIG. 15, according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Advantages and features of the present disclosure and a method of achieving the advantages and features will be apparent by referring to exemplary embodiments described below in connection with the accompanying drawings. However, the present disclosure is not restricted by these exemplary embodiments but can be implemented in many different forms. The present exemplary embodiments are provided to complete the disclosure of the present invention and to allow those having ordinary skill in the art to understand the scope of the present invention. The present invention is defined by the category of the claims.

Hereinafter, exemplary embodiments of the present disclosure will be described in detail with reference to the accompanying drawings so that the present disclosure may be readily implemented by those skilled in the art. In the drawings, parts irrelevant to the description are omitted for the simplicity of explanation.

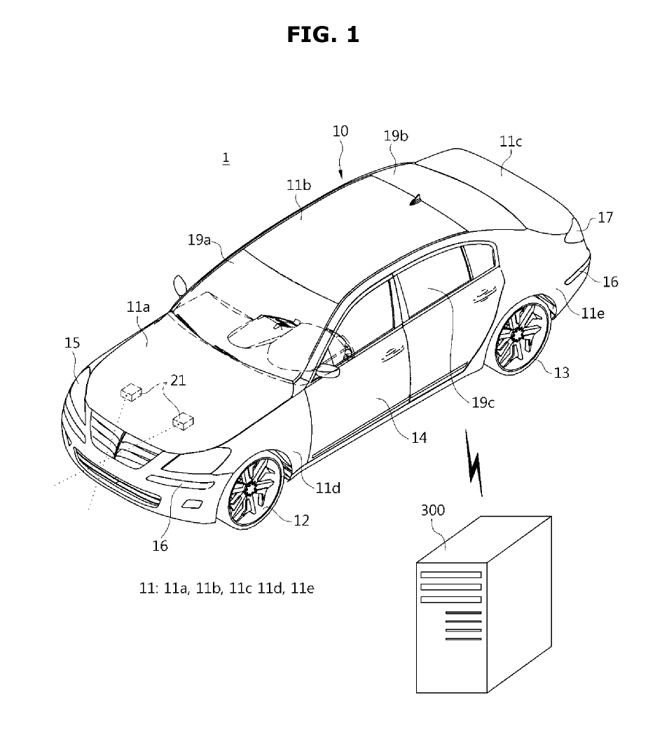

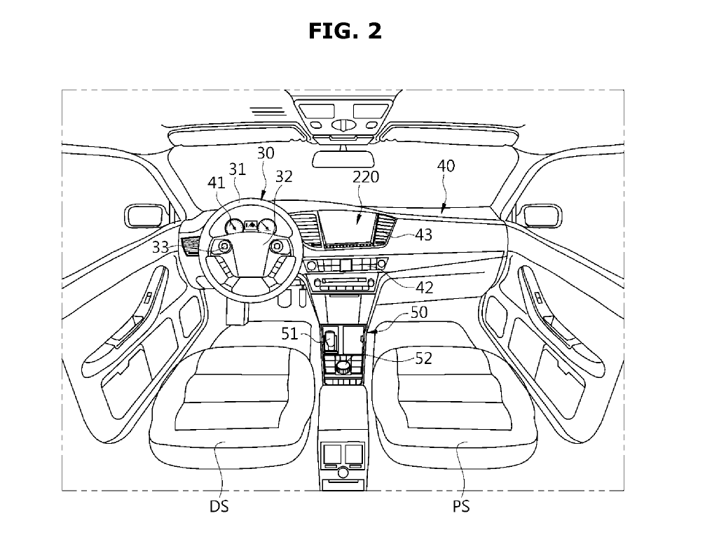

FIG. 1 is an exemplary view of a vehicle system according to an exemplary embodiment of the present disclosure, and FIG. 2 shows the interior of a vehicle system according to an exemplary embodiment of the present disclosure. Referring to FIGS. 1 and 2, a vehicle system 1 according to an exemplary embodiment of the present disclosure may include a vehicle 10, and a regulations management apparatus 300 configured to communicate with the vehicle 10. Hereinafter, the components of the vehicle system 1 will be described in detail.

As shown in FIG. 1, the vehicle 10 may include a vehicle body 11 that forms an external appearance of the vehicle 10, and a plurality of wheels 12 and 13 used to move the vehicle 10. The vehicle body 11 may include a hood 11a to protect various devices such as an engine required for driving the vehicle 10, a loop panel 11b that forms the internal space of the vehicle 10, a trunk lid 11c to provide storage space, and front fenders 11d and quarter panels 11e disposed at both sides of the vehicle 10. Additionally, a plurality of doors 14 hinge-coupled with the vehicle body 11 may be disposed at both sides of the vehicle body 11.

A front window 19a that provides a front view of the vehicle 10 may be disposed between the hood 11a and the loop panel 11b, and a rear window 19b that provides a back view of the vehicle 10 may be disposed between the loop panel 11b and the trunk lid 11c. A plurality of side windows 19c that provide side views of the vehicle 10 may be disposed at the upper parts of the doors 14.

A plurality of headlamps 15 configured to irradiate light in a heading direction of the vehicle 10 may be disposed at the front part of the vehicle 10. The headlamps 15 may be configured to operate in a low beam mode to irradiate light to a short distance (e.g., about 30 m) from the vehicle 10, or in a high beam mode to irradiate light to a long distance (e.g., about 100 m) from the vehicle 10. In addition, a plurality of turn signal lamps 16 configured to provide notification of a movement direction of the vehicle 10 may be disposed at the front and back parts of the vehicle 10. The turn signal lamps 16 may be configured to flicker to provide a notification to traveling vehicles or pedestrians of a movement direction of the vehicle 10. A plurality of tail lamps 17 may be also be disposed at the back part of the vehicle 10. The tail lamps 17 may be configured to provide notification of a gear shifting state, a brake operation state, or the like of the vehicle 10.

As shown in FIG. 2, the interior of the vehicle 10 may include a plurality of seats, a steering wheel 30 to change a movement direction of the vehicle 10, a dash board 40 in which various meters for displaying driving information of the vehicle 10 are installed to control operations of the vehicle 10, and a gear box 50 disposed below the dash board 40.

The seats may include a driver seat DS, a passenger seat PS, and a back seat (not shown) disposed in the back part of the vehicle 1 (e.g., behind the driver seat and the passenger seat). The steering wheel 30 may include a rim 31 to be gripped by a driver, and a spoke 32 that connects the rim 31 to a hub of a steering apparatus located on a rotation axis for steering. A driver may manipulate the rim 31 to rotate the spoke 32 to change the directions of the wheels 21 and 22, thereby adjusting a driving direction of the vehicle 1.

Further, the steering wheel 30 may further include a first input unit 33 which may be used to control various functions of the vehicle 10. For example, a driver may use the first input unit 33 to operate an audio/video system or to set a cruise function of automatically adjusting the speed of the vehicle 10. The first input unit 33 may include a scroll wheel, a button, a knob, a touch screen, a touch pad, a lever, a trackball, an operating sensor, or a voice recognition sensor.

The dash board 40 may include a cluster 41 to display speed, Revolutions Per Minute (RPM), or fuel gauge of the vehicle 1, a center fascia 42 in which a manipulation unit for operating the audio/video system, an air conditioner, or a heater is installed, and a ventilator 43 to suction air into the vehicle 1. The gear box 50 in which a gear apparatus is installed may be disposed below the center fascia 42. A gear handle 51 for shifting a gear may protrude from the gear box 50.

Additionally, the gear box 50 may include a second input unit 52 to enable the driver to input various commands for manipulating various functions of the vehicle 1. For example, the driver may input information regarding a destination to a navigation system 220 through the second input unit 52. The second input unit 52 may include at least one of a knob, a physical button, a joystick, a lever, a trackball, a manipulating wheel, an operating sensor, an object detection sensor, and a touch sensor. The second input unit 52 may also include various input means that one of ordinary skill in the art can consider.

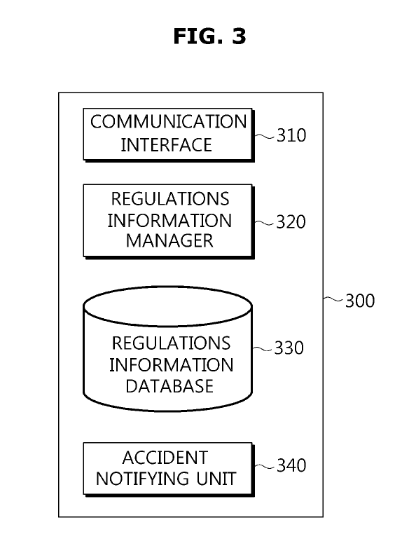

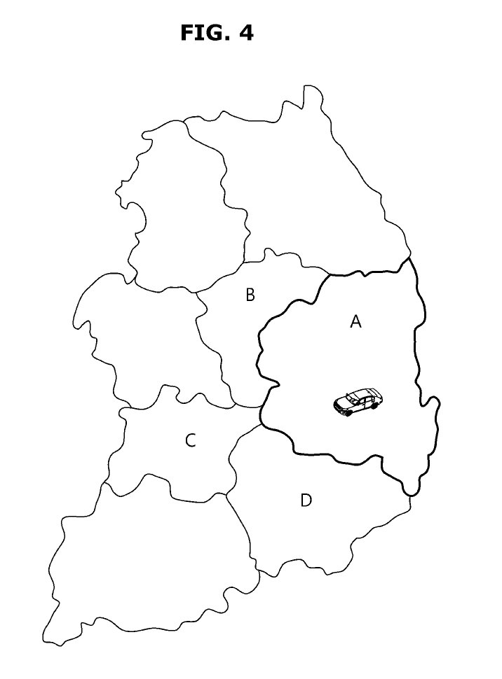

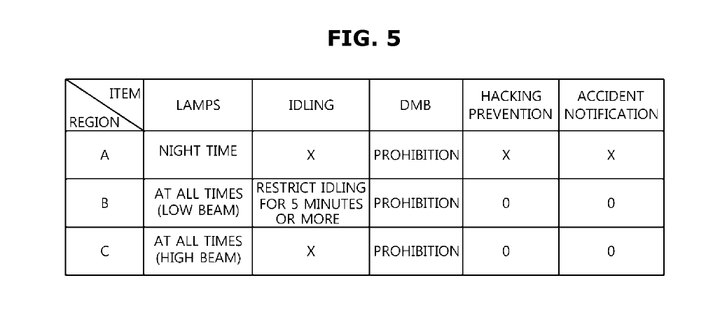

FIG. 3 is an exemplary control block diagram of the regulations management apparatus 300 included in the vehicle system 1 according to an exemplary embodiment of the present disclosure, FIG. 4 is an exemplary view for describing region classification that is performed by the vehicle system 1 according to an exemplary embodiment of the present disclosure, and FIG. 5 is an exemplary view for describing regulations information database included in the vehicle system 1 according to an exemplary embodiment of the present disclosure.

As shown in FIGS. 1 and 3, the vehicle 10 according to an exemplary embodiment of the present disclosure may communicate with the regulations management apparatus 300. Hereinafter, regulations information means information regarding various legal restrictions related to driving of the vehicle 10, and may include a plurality of items. For example, regulations information may include a plurality of items including lighting settings of the vehicle 10, audio/video settings of the vehicle 10, speed settings of the vehicle 10, or application installation of the vehicle 10. The number and contents of items included in the regulations information may depend on the content of the regulations information.

Furthermore, the regulations information may include recommended items that a driver driving the vehicle 10 is recommended to observe, as well as required items. For example, when it is recommended to restrict idling for 5 minutes or more, the regulations information may include a recommended item related to idling. The regulations information may further include programs that the vehicle 10 is either required or recommended to install. For example, when a regulation of installing a program for preventing hacking into a vehicle is enacted, the regulations information may include a program for hacking prevention.

More specifically, the regulations management apparatus 300 may include a plurality of elements executed by a controller. In particular, the elements may include communication interface 310 configured to support communications with the vehicle 10, a regulations information manager 320 configured to manage regulations information, regulations information database 330 configured to store regulations information, and an accident notifying unit 340 configured to receive information regarding accidents of the vehicle 10 and respond to the accidents of the vehicle 10. The communication interface 310 may be configured to support communications between the vehicle 10 and the regulations management apparatus 300. The communication interface 310 may be connected to the vehicle 10 via one of various communication protocols.

For example, the communication interface 310 may be connected to the vehicle 10 via a wired communication protocol or a wireless communication protocol, wherein the wireless communication protocol includes Transmission Control Protocol (TCP), Global System for Mobile Communication (GSM), Code Division Multiple Access (CDMA), Wideband Code Division Multiple Access (WCDMA), Time Division Multiple Access (TDMA), Long Term Evolution (LTE), etc.

The regulations management apparatus 300 may be configured to exchange data with the vehicle 10 via the communication interface 310. For example, the regulations management apparatus 300 may be configured to transmit regulations information stored in the regulations information database 330 to the vehicle 10 via the communication interface 310. The regulations information manager 320 may then be configured to manage regulations information for individual regions. Since legal restrictions applied to the traveling vehicle 10 may vary based on region, the regulations information manager 320 may be configured to manage regulations information for individual regions.

According to an exemplary embodiment, the regulations information manager 320 may further be configured to manage regulations information based on individual regions classified based on countries or administrative districts. For example, the regulations information manager 320 may be configured to manage regulations information by classifying regions in a unit of application of regulations, such as country, state, or city.

According to another exemplary embodiment, the regulations information manager 320 may be configured to manage regions based on the identity of regulations information. Since some countries or administrative districts apply the same legal restrictions for vehicles, the regulations information manager 320 may be configured to classify regions according to the identity of regulations information, as shown in FIG. 4. For example, since some countries apply the same regulations, the countries may be classified into a single region.

Additionally, the regulations information manager 320 may be configured to collect any change in regulations at regular time intervals or in real time. When a regulation changes, the regulations information manager 320 may be configured to correct regulations information based on the changed regulation. The regulations information manager 320 may also be configured to determine whether regulations information requires an update, according to a request from the vehicle 10, and transmit regulations information to the vehicle 10 when regulations information requires the update.

According to an exemplary embodiment, when the regulations information manager 320 determines that regulations information stored in the vehicle 10 is different from regulations information stored in the regulations information database 330, the regulations information manager 320 may be configured to determine that regulations information of the vehicle 10 requires an update.

According to another exemplary embodiment, the regulations information manager 320 may be configured to manage an update history to determine whether regulations information requires an update. The update history may be update-related information, such as a time at which the regulations information has been corrected or a version of the regulations information. The regulations information manager 320 may be configured to determine whether regulations information requires an update, based on the update history, such as the time at which the regulations information has been corrected or the version of the regulations information.

The regulations information database 330 may be configured to store regulations information for individual regions. The regulations information database 330 may be configured to store regulations information based on a predetermined data structure, and seek and output regulations information according to a request from the regulations information manager 320. For example, the regulations information database 330 may be configured to store regulations information as shown in FIG. 5. Referring to FIG. 5, the regulations information may be configured with a plurality of items of “lamps”, “idling”, “DRL(Daytime Running Light)”, “hacking prevention”, and “accident notification”. In particular, FIG. 5 is an exemplary view for describing regulations information, and the types and number of items included in the regulations information are not limited to those shown in FIG. 5. Meanwhile, when additional programs for observing regulations are required like the items of “hacking prevention” and “accident notification”, the regulations information may further include such additional programs. The accident notifying unit 340 may be configured to manage accident information transmitted from the vehicle 10. When the accident notifying unit 340 receives accident information via the communication interface 310, the accident notifying unit 340 may be configured to store the accident information. Additionally, the accident notifying unit 340 may be configured to transmit the accident information to related organizations, such as a hospital, a police station, etc., to rapidly response to the accident.

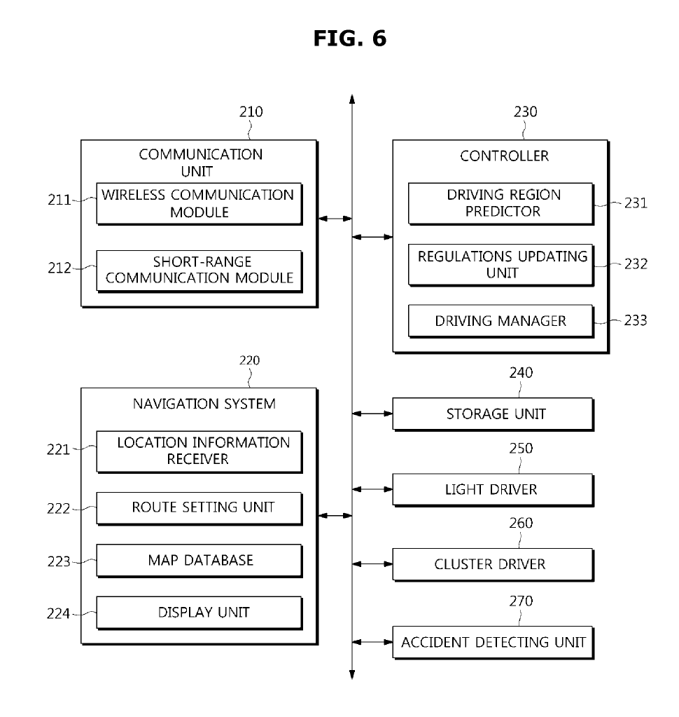

Hereinafter, operations of the vehicle system 1 according to an exemplary embodiment of the present disclosure will be described in detail with reference to FIG. 6. Referring to FIG. 6, the vehicle 10 may include a communication unit 210 configured to communicate with an external device, a navigation system 220 configured to display a location of the vehicle 10 on a map output on a display, a controller 230 to operate driving of the vehicle 10, a storage unit 240 configured to store data required for driving the vehicle 10, a plurality of drivers 250 and 260 configured to drive the individual components of the vehicle 10, and an accident detecting unit 270 configured to detect an accident of the vehicle 10. Although the various above units are described individually, the various units may be implemented within and executed by the controller 230.

The communication unit 210 may be connected to the regulations management apparatus 300 to exchange data with the regulations management apparatus 300. For example, the communication unit 210 may be connected to the regulations management apparatus 300 to download regulations information received by the regulations management apparatus 300. The communication unit 210 may include a wireless communication module 211 and a short-range communication module 212. The wireless communication module 211 may be configured to exchange data with the regulations management apparatus 300 using a wireless communication protocol. For example, the wireless communication module 211 may connect to a communication network via a wireless communication protocol, such as a GSM/3rd Generation Partnership Project (3GPP)-based communication method (for example, GSM, High Speed Downlink Packet Access (HSDPA), or LTE Advanced), a 3GPP2-based communication method (for example, CDMA), or Worldwide Interoperability for Microwave Access (WiMAX).

The short-range communication module 212 may be configured to exchange data with the regulations management apparatus 300 using a short-range communication protocol. For example, the short-range communication module 212 may connect to an adjacent device using a short-range communication protocol, such as Bluetooth, Bluetooth low energy, Infrared Data Association (IrDA), Zigbee, Wireless Fidelity (Wi-Fi), Wi-Fi Direct, Ultra Wideband (UWB), or Near-Field Communication (NFC), to connect to a communication network.

Further, the navigation system 220 may include a location information receiver 221 configured to receive location information from global positioning system (GPS) satellites, a route setting unit 222 configured to set a driving route toward a destination, map database 223 configured to store a map, and a display unit 224 configured to display information for a driver regarding the driving route. The location information receiver 221 may be configured to communicate with GPS satellites to receive information regarding a current location of the vehicle 10. In addition, the location information receiver 221 may be configured to map the current location of the vehicle 10 onto a map stored in the map database 223. The route setting unit 222 may then be configured to set a driving route toward a destination based on the map stored in the map database 223. The route setting unit 222 may further be configured to seek a route according to a predetermined algorithm. A driver may also input information regarding the destination through the first input unit 33 or the second input unit 52 as shown in FIG. 2.

Furthermore, the route setting unit 222 may be configured to seek (e.g., determine) a plurality of routes (e.g., various alternate routes) toward the destination, and set a route selected from among the detected routes as a driving route. For example, the route setting unit 222 may be configured to detect a shortest distance route to arrive at the destination, a shortest time route to arrive at the destination, a fee-free route, and a fast route, and provide the results to the driver. Then, the route setting unit 222 may be configured to set a route selected by the driver from among the detected routes as a driving route. Alternatively, the route setting unit 222 may be configured to pre-select a driving route from the detected routes based on preset driver preferences.

The display unit 224 may be configured to display the driving route on a map. In particular, the driving route may be display on a map after zooming in and out of the map or after dividing a screen to mark the driving route, to allow the driver to comprehend the driving route. The display unit 224 may be embodied with a Plasma Display Panel (PDP), a Liquid Crystal Display (LCD) panel, a Light Emitting Diode (LED) panel, or an Organic Light Emitting Diode (OLED) panel, or an Active-matrix Organic Light-Emitting Diode (AMOLED) panel, although the display unit 224 is not limited to these panels. The display unit 224 may also be a touch screen. When the display unit 224 is a touch screen, pressure may be applied to the display unit 224 to detect a destination, or to change settings of the navigation system 220.

Meanwhile, the navigation system 220 may further include an audio system and a video system (AVN). For example, the navigation system 220 may provide the driver with Digital Multimedia Broadcasting (DMB). The storage unit 240 may be configured to store various data required for driving the vehicle 10. More specifically, the storage unit 240 may be configured to store Operating System (OS) and applications required for driving the vehicle 10, and store temporary data generated during driving of the vehicle 10.

Further, the storage unit 240 may be configured to store regulations information. More specifically, the storage unit 240 may be configured to store regulations information for individual regions. The storage unit 240 may also be configured to manage an update history of regulations information together with the regulations information. The update history may be information used to determine whether the regulations information has been updated, such as a date at which the regulations information was previously downloaded or version information of the regulations information.

A light driver 250 may be configured to operate lamps of the vehicle 10 according to a control signal from the controller 230. For example, the light driver 250 may be configured to turn on and off the headlamps 15, the tail lamps 17, or the turn signal lamps 16, according to a control signal from the controller 230. A cluster driver 260 may be configured to drive the cluster 41 according to a control signal from the controller 230. For example, the cluster driver 260 may be configured to display information related to download of regulations information or any change of regulations according to a control signal from the controller 230.

Additionally, the storage unit 240 may include high-speed random access memory, a magnetic disk, Static Random Access Memory (SRAM), Dynamic Random Access Memory (DRAM), Read-Only Memory (ROM), etc., although the storage unit 240 is not limited to these. The storage unit 240 may be attached to or detached from the vehicle 10. For example, the storage unit 240 may include a Compact Flash (CF) card, a Secure Digital (SD) card, a Smart Media (SM) card, a Multimedia Card (MMC), or a memory stick, although the storage unit 240 is not limited to these.

The controller 230 may be configured to operate the driving of the vehicle 10. In particular, the controller 230 may be configured to operate the individual components of the vehicle 10 so that the vehicle 10 observes regulations during driving. The controller 230 may further be configured to determine whether regulations information of a driving region which the vehicle 10 is expected to enter has been updated, and when the controller 230 determines that regulations information requires an update, the controller 230 may be configured to update regulations information before the vehicle 10 enters the driving region. Hereinafter, the controller 230 will be described in detail.

The controller 230 may include a driving region predictor 231 configured to predict a driving region, a regulations updating unit 232 configured to manage update of regulations information, and a driving manager 233 configured to manage driving according to the regulations. The driving region predictor 231 may be configured to predict a driving region of the vehicle 10. In particular, the driving region predictor 231 may be configured predict a driving region of the vehicle 10 based on at least one of information regarding location information and route information of the vehicle 10. Hereinafter, a region to which the vehicle 10 is expected to enter is referred to as an expected driving region, and a region in which the vehicle 10 is currently traveling is referred to as a current driving region.

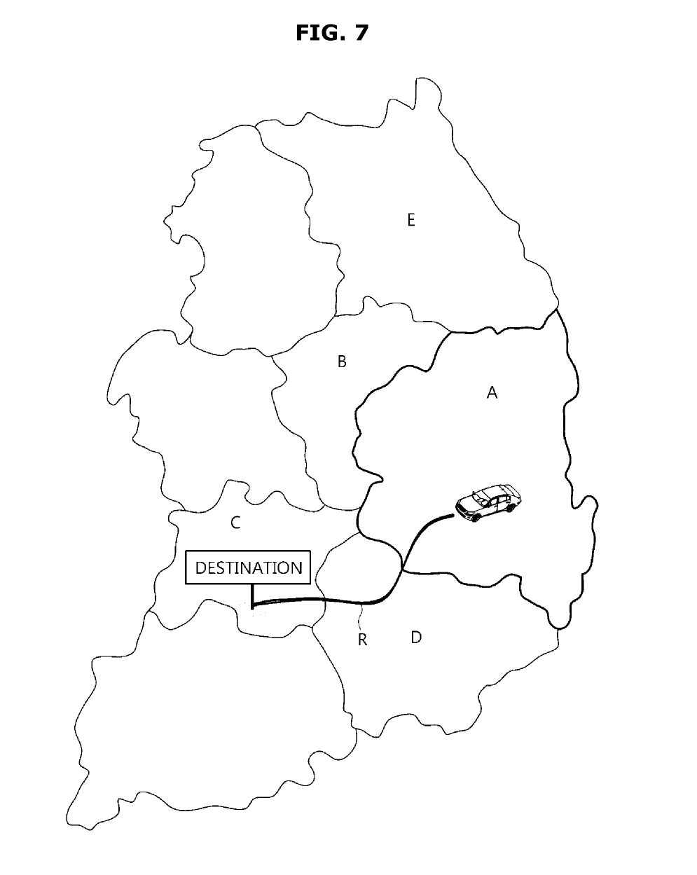

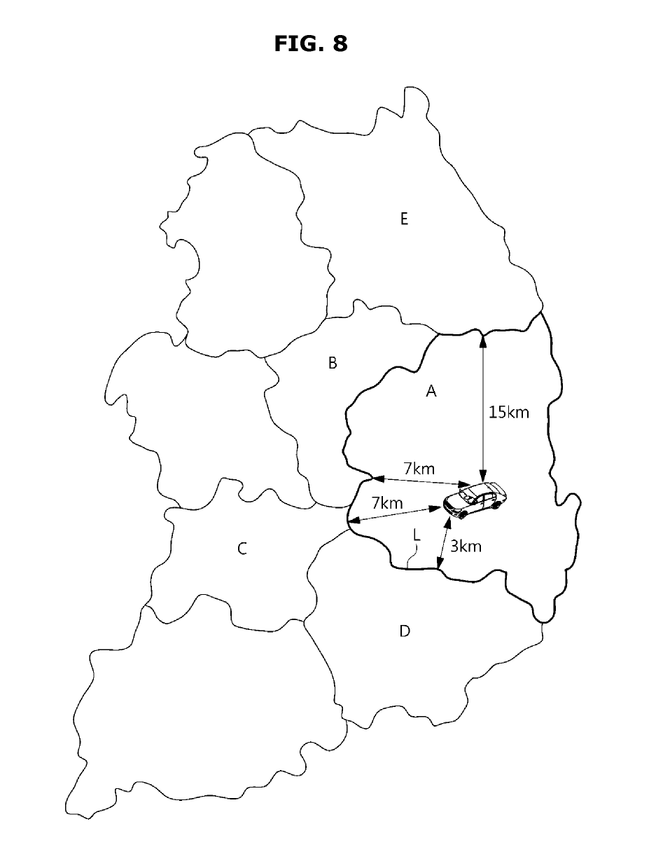

Hereinafter, route prediction of the vehicle 10 will be described in detail with reference to FIGS. 7 and 8. In particular, FIG. 7 is an exemplary view for describing vehicle route prediction according to an exemplary embodiment of the present disclosure, and FIG. 8 is an exemplary view for describing vehicle route prediction according to another exemplary embodiment of the present disclosure. The following descriptions will be given with reference to FIGS. 6, 7, and 8.

According to an exemplary embodiment of predicting a driving region, the driving region predictor 231 may be configured to predict a driving region based on a driving route set by the route setting unit 222. The driving route may be generated based on a current location of the vehicle 10 and a destination, and the vehicle 10 may be expected to travel toward the destination along the driving route.

Accordingly, the driving region predictor 231 may be configured to predict regions in which the driving route of the vehicle 10 is included, as driving regions, as shown in FIG. 7. For example, when a driving route R along which the vehicle 10 at a region A travels toward a destination via regions D and C is set, the driving region predictor 231 may be configured to set the regions C and D in which the driving route R is included to expected driving regions.

According to another exemplary embodiment of predicting a driving region, the driving region predictor 231 may be configured to determine an expected driving region based on distances of the vehicle 10 to regions. In other words, the driving region predictor 231 may be configured to calculate distances from the vehicle 10 to regions that are adjacent to a current driving region of the vehicle 10, and predict a region that is within a predetermined distance from the vehicle 10, as an expected driving region.

For example, the driving region predictor 231 may be configured to calculate, as shown in FIG. 8, distances from the vehicle 10 to regions B, C, D, and E that are adjacent to a region A in which the vehicle 10 is currently traveling, respectively. Then, the driving region predictor 231 may be configured to predict a region that is within a predetermined distance K from the vehicle 10, as an expected driving region. When K is about 5 km, the driving region predictor 231 may be configured to set the region D to an expected driving region, and when K is about 10 km, the driving region predictor 231 may be configured to set the regions B, C, and D to expected driving regions.

However, a method of determining an expected driving region is not limited thereto. The driving region predictor 231 may be configured to store a previous traveling route of the vehicle 10, and determine an expected driving region based on the previous traveling route. For example, when the vehicle 10 has traveled from the region A to a region E a predetermined number of times, the driving region predictor 231 may be configured to determine the region E as an expected driving region. When the vehicle 10 is traveling toward the region E for a predetermined time period or greater, the driving region predictor 231 may be configured to determine the region E as an expected driving region.

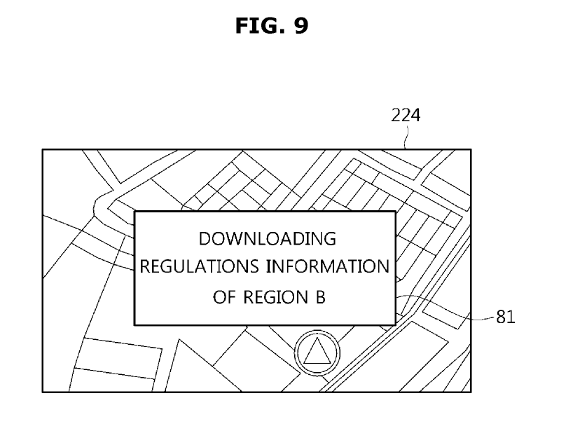

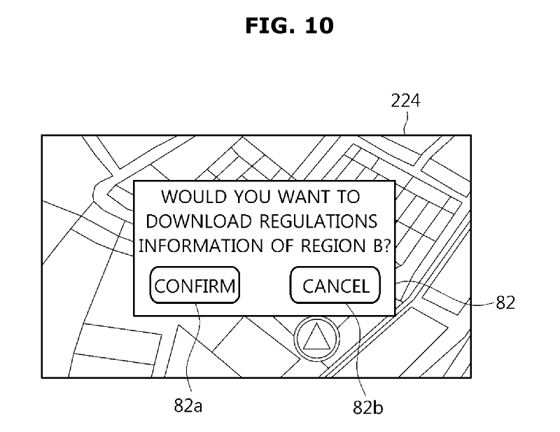

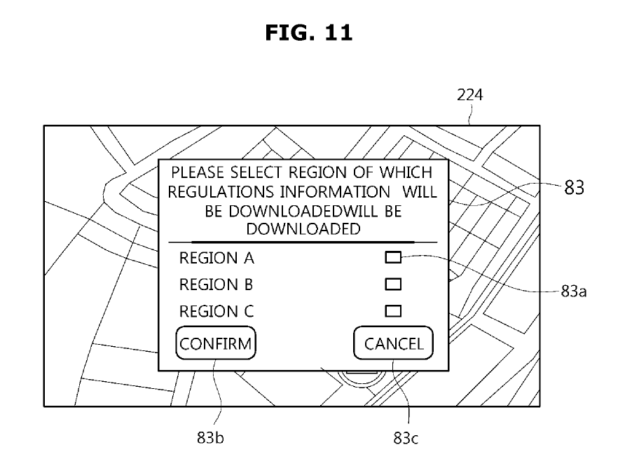

FIG. 9 shows an example of a navigation screen that is displayed when regulations information is being downloaded, FIG. 10 shows an example of a navigation screen for receiving a download start command to download regulations information, and FIG. 11 shows another example of a navigation screen for receiving a download start command to download regulations information.

The regulations updating unit 232 may be configured to update regulations information. In particular, the regulations updating unit 232 may be configured to determine whether regulations information regarding an expected driving region has been updated, and when the regulations updating unit 232 determines that regulations information of the expected driving region has been updated, the regulations updating unit 232 may be configured to update regulations information of the expected driving region.

The regulations updating unit 232 may connect to the regulations management apparatus 300 via the communication unit 210, and may be configured to transmit an inquiry to the regulations management apparatus 300 regarding whether regulations information has been updated. The regulations updating unit 232 may be configured to determine whether to update regulations information, according to a response from the regulations management apparatus 300. More specifically, the regulations updating unit 232 may be configured to operate the communication unit 210 to connect to the regulations management apparatus 300 to determine whether regulations information of the expected driving region has been updated.

According to an exemplary embodiment of determining whether regulations information of the expected driving region has been updated, the regulations updating unit 232 may be configured to compare regulations information stored in the storage unit 240 to regulations information stored in the regulations management apparatus 300. In other words, when regulations information stored in the storage unit 240 is different from regulations information stored in the regulations management apparatus 300, the regulations updating unit 232 may be configured to determine that regulations information requires an update. Additionally, when regulations information stored in the storage unit 240 is the same as regulations information stored in the regulations management apparatus 300, the regulations updating unit 232 may be configured to determine that regulations information does not require an update (e.g., determine that the regulations information is up to date or previously updated).

According to another exemplary embodiment of determining whether regulations information of the expected driving region has been updated, the regulations updating unit 232 may determine whether regulation information has been updated, based on an update history. For example, the regulations updating unit 232 may be configured to compare a version of regulations information stored in the storage unit 240 to a version of regulations information stored in the regulations management apparatus 300 to determine whether regulations information has been updated. In addition, the regulations updating unit 232 may be configured to compare a time at which regulations information stored in the storage unit 240 has been last updated to a time at which regulations information stored in the regulations management apparatus 300 has been updated to determine whether regulations information has been updated.

Particularly, the regulations updating unit 232 may be configured to update, when updating regulations information, an update history enabling determination on whether regulations information has been updated, such as an update time of the regulations information or a version of the regulations information. When the regulations updating unit 232 determines that regulations information requires an update, the regulations updating unit 232 may be configured to operate the communication unit 210 to download regulations information of the expected driving region.

Moreover, the regulations updating unit 232 may be configured to display, when downloading regulations information, a download progress of the regulations information for a driver through an interface disposed within the vehicle 10. For example, as shown in FIG. 9, the regulations updating unit 232 may be configured to operate the navigation system 220 to display a pop-up window 81 providing a notification that regulations information is being downloaded on the display unit 224. In addition, the regulations updating unit 232 may be configured to operate the cluster driver 260 to display a download progress of regulations information through the cluster 41.

Meanwhile, regulations information may start to be downloaded by the driver's input. More specifically, when the regulations updating unit 232 determines that regulations information requires an update, the regulations updating unit 232 may be configured to operate the navigation system 220 to display a pop-up window 82 for receiving confirmation regarding whether to update regulations information on the display unit 224, as shown in FIG. 10. Then, the driver may select a “Confirm” button 82a and a “Cancel” button 82b displayed on the pop-up window 82 to decide whether to update regulations information. When a plurality of expected driving regions require an update, the regulations updating unit 232 may be configured to update regulations information of an expected driving region selected by the driver from among the expected driving regions.

As shown in FIG. 11, the regulations updating unit 232 may be configured to display a pop-up window 83 that includes a list of a plurality of expected driving regions on the display unit 224. The pop-up window 83 may include a plurality of check boxes 83a (e.g., selection areas) to allow the driver to select one or more regions of which regulations information will be downloaded from among the expected driving regions, a “Confirm” button 83b to allow the driver to input a download start command, and a “Cancel” button 83c to cancel download.

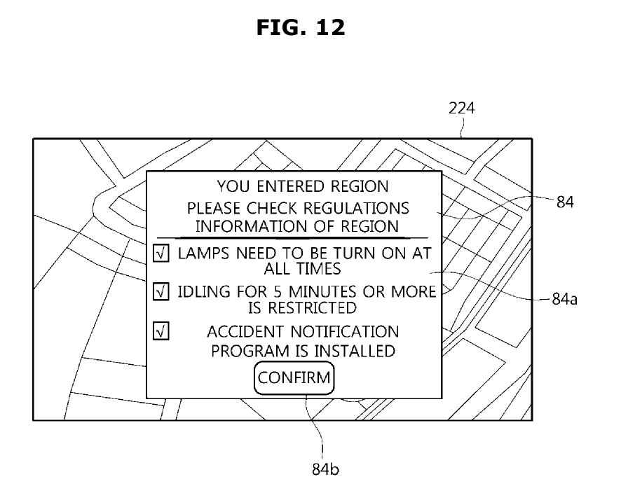

FIG. 12 shows an example of a navigation screen that is displayed when the vehicle 10 enters a region to which different regulations are applied. The driving manager 233 may be configured to manage driving of the vehicle 10 according to updated regulations information. More specifically, the driving manager 233 may be configured to monitor whether the vehicle 10 enters an expected driving region, based on location information received from the navigation system 220. When the driving manager 233 determines that the vehicle 10 enters an expected driving region, the driving manager 233 may be configured to adjust the driving of the vehicle 10 according to regulations information of the region to which the vehicle 10 enters.

Additionally, the driving manager 233 may be configured to change settings of the vehicle 10, or additionally install software, based on downloaded regulations information. In other words, the driving manager 233 may be configured to output control signals to the plurality of drivers 250 and 260 to change settings of the vehicle 10 to operate the individual components of the vehicle 10 based on the regulations information. The driving manager 233 may additionally install software. As described above, additional software may be required to be installed or software may be required to be changed to observe regulations (e.g., to comply with regulations).

For example, when a regulation requires the installation of software, such as a hacking prevention program or an accident notification program, the downloaded regulations information may include such software. Accordingly, when software is included in the regulations information, the driving manager 233 may be configured to install the software (e.g., a hacking prevention program or an accident notification program) included in the regulations information.

Herein, the hacking prevention program is a program for preventing hacking into remote control of the vehicle 10 using telematics, and the accident notification program is a program for automatically transmitting, when an accident is detected, information regarding the accident. In other words, the driving manager 233 may be configured to change settings of the vehicle 10, or change, install, or delete software, to satisfy the individual items of the regulations information. Hereinafter, an exemplary embodiment of driving control will be described in detail with reference to FIGS. 3, 5, 6, and 7.

Referring to FIGS. 3, 5, 6, and 7, when the vehicle 10 enters the region D from the region A, the driving manager 233 may be configured to operate the vehicle 10 according to regulations information of the region D. For example, the driving manager 233 may be configured to operate the light driver 250 to cause the headlamps 15 to irradiate low beams even during the daytime, according to the regulations information. The driving manager 233 may also be configured to stop the engine forcibly when idling continues for about 5 minutes or more.

In addition, when the vehicle 10 enters the region D from the region A, the driving manager 233 may be configured to operate the navigation system 220 to display a pop-up window 84 as shown in FIG. 12. The vehicle 10 may be configured to execute the hacking prevention program and the accident notification program. When neither a hacking prevention program nor an accident notification program have been installed, the driving manager 233 may be configured to additionally install the hacking prevention program and the accident notification program included in the regulations information.

When the vehicle 10 enters the region C from the region D, the driving manager 233 may be configured to operate the light driver 250 to cause the headlamps 15 to irradiate high beams even during the daytime according to the regulations information. After the driving manager 233 entered the region C, the driving manager 233 may be configured to prevent the engine from stopping even when the vehicle 10 idles. Since viewing DMB may be allowed in the region C, DMB may continue to be provided during driving.

Accordingly, by adjusting driving of the vehicle 10 according to the latest regulations information, it may be possible to operate the vehicle 10 to satisfy or comply with regulations restrictions for individual regions, while avoiding difficulties in maintaining and managing the vehicle 10 due to excessive responses to regulations. Additionally, when a driving region of the vehicle 10 has changed, the controller 230 may be configured to display regulations information of the changed region. In particular, the controller 230 may be configured to display all items of the regulations information, or selectively display some items of the regulations information. The controller 230 may specifically be configured to display regulations information regarding an expected driving region for a driver, during or before a current driving region changes to the expected driving region, to induce the driver to observe the regulations. Accordingly, the controller 230 may be configured to selectively display changed items in the regulations information of the expected driving region.

Meanwhile, the controller 230 may correspond to one or more processors. The processor may be implemented as an array of a plurality of logic gates, or as a combination of a general-purpose microprocessor and a memory storing a program that can be executed on the microprocessor. However, it will be obvious to one of ordinary skill in the art that the controller 260 can be implemented as a different kind of hardware. Furthermore, in FIG. 6, the controller 230 may include the driving region predictor 231, the regulations updating unit 232, and the driving manager 233, however, the driving region predictor 231, the regulations updating unit 232, and the driving manager 233 may be implemented as a single processor. In FIG. 6, the controller 230 and the navigation system 220 are provided as separate components, however, the controller 230 and the navigation system 220 may be implemented as a single apparatus.

In particular, the accident detecting unit 270 may be configured to detect an accident of the vehicle 10. For example, the accident detecting unit 270 may be configured to detect occurrence of an accident through an impact sensor to sense any impact applied to the vehicle 10, or based on operation of airbags. The aforementioned accident notification program may be installed in the accident detecting unit 270. When an accident has occurred, the accident notification program may be configured to collect accident information, such as an accident occurrence time, location information of the vehicle 10, and accident information of the vehicle 10, and transmit the collected accident information to the regulations management apparatus 300 or to related organizations, such as a police station, a hospital, etc.

Meanwhile, the above description relates to an example in which the vehicle 10 is directly connected to the regulations management apparatus 300, however, the present disclosure is not limited to this.

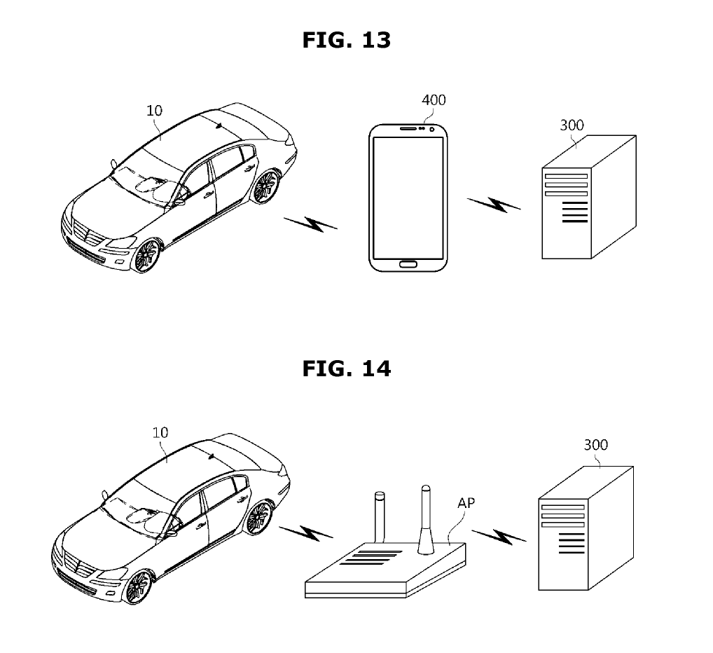

FIG. 13 shows a vehicle system according to another exemplary embodiment of the present disclosure, and FIG. 14 shows a vehicle system according to still another exemplary embodiment of the present disclosure. In other words, the vehicle 10 may be connected to the regulations management apparatus 300 via a relay device. More specifically, as shown in FIG. 13, a user terminal 400 may be configured to relay data between the vehicle 10 and the regulations management apparatus 300.

In other words, the vehicle 10 may be configured to connect to the user terminal 400 disposed inside of or in the vicinity of the vehicle 10, and the user terminal 400 may connect to a regulation management server via a wired/wireless communication network, thus connecting the vehicle 10 to the regulations management apparatus 300. For example, the user terminal 400 may connect to the regulations management apparatus 300 via wireless communication, and to the vehicle 10 via short-range communication such as Wi-Fi. Herein, the user terminal 400 may be a device with both short-range communication capability and long-range communication capability, such as a notebook, a Portable Media Player (PMP), a Personal Digital Assistant (PDA), a tablet PC, or a smart phone.

As shown in FIG. 14, the vehicle 10 may connect to the regulations management apparatus 300 via an Access Point (AP). In particular, the vehicle 10 may connect to the AP according to a short-range communication protocol, and the AP may connect to the regulations management apparatus 300 according to a wired communication protocol. The AP may be installed in public facilities, such as a gas station, a service center, a rest region, etc. Since the AP or the user terminal 400 with long-range communication capability may be configured to relay data between the vehicle 10 and the regulations management apparatus 300, it may be possible to provide a regulations information update service to vehicles that do not use a telematics service.

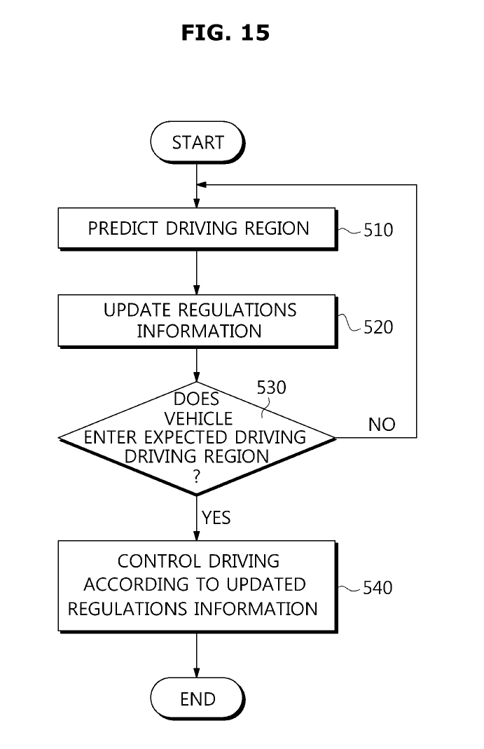

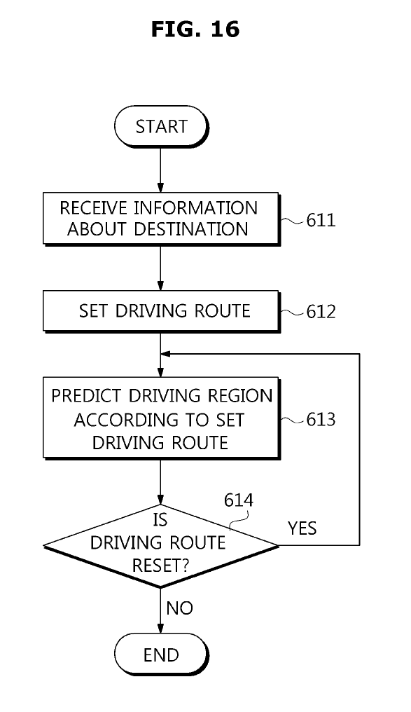

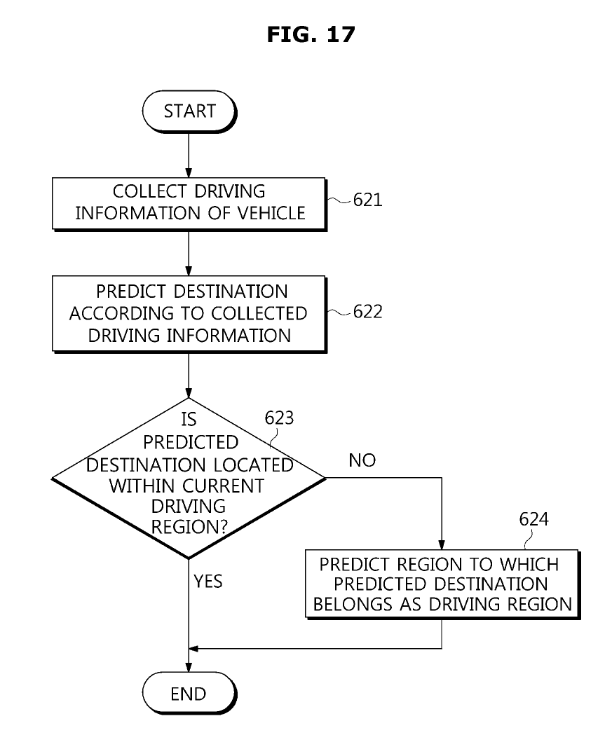

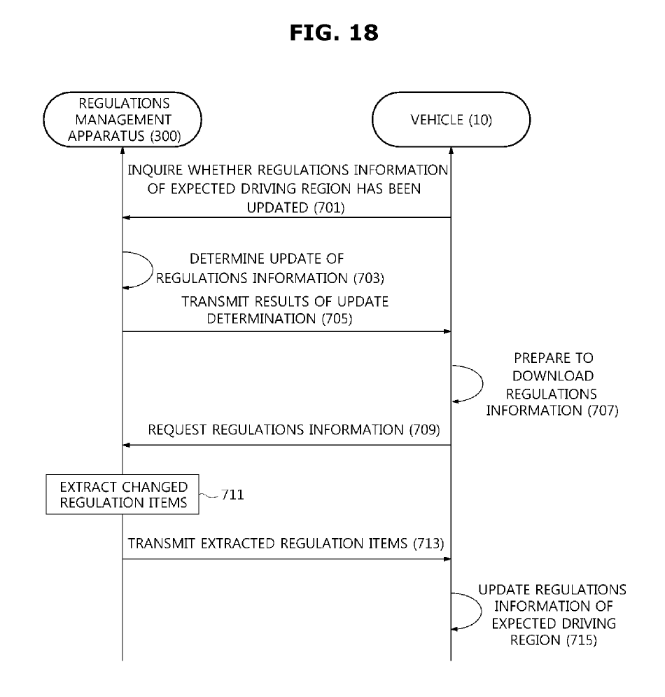

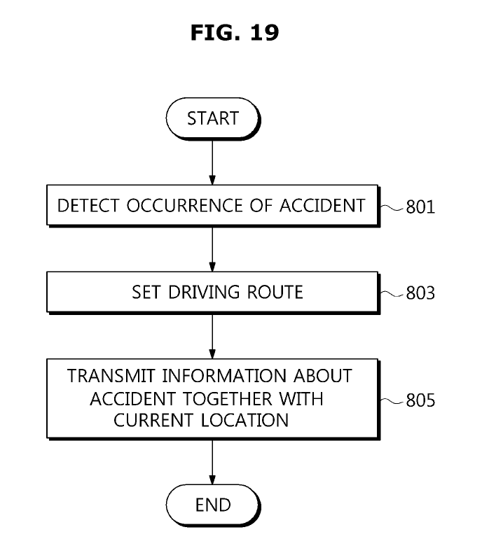

Hereinafter, a control method of a vehicle according to an exemplary embodiment of the present disclosure will be described in detail with reference to FIG. 15. FIG. 15 is a flowchart illustrating a control method of a vehicle, according to an exemplary embodiment of the present disclosure, FIG. 16 is a flowchart illustrating operation of predicting a driving region in the control method of FIG. 15, according to an exemplary embodiment of the present disclosure, FIG. 17 is a flowchart illustrating operation of predicting a driving region in the control method of FIG. 15, according to another exemplary embodiment of the present disclosure, FIG. 18 is a flowchart illustrating operation of updating regulations information in the control method of FIG. 15, according to an exemplary embodiment of the present disclosure; and FIG. 19 is a flowchart illustrating operation of controlling driving in the control method of FIG. 15, according to an exemplary embodiment of the present disclosure. Each of the operations within the flowcharts may be implemented by the controller described herein.

Referring to FIGS. 1, 6, and 15, the vehicle 10 may be configured to predict a driving region, in operation S510. More specifically, the vehicle 10 may be configured to predict a driving region based on location information of the vehicle 10 received from the navigation system 220. According to an exemplary embodiment of predicting a driving route, the vehicle 10 may be configured to predict a driving region based on a driving route set by the navigation system 220. As shown in FIG. 16, the navigation system 220 of the vehicle 10 may be configured to receive information regarding a destination from a user in operation S611, and set a driving route from a current location of the vehicle 10 to the destination in operation S612. The navigation system 220 may then be configured to determine a plurality of routes toward the destination, and provide the determined routes to the user to allow a route to be selected from among the plurality of routes, and set the selected route to a driving route.

The vehicle 10 may be configured to predict a driving region according to the driving route set by the navigation system 220, in operation 613. Since the driving route of the navigation system 220 may be generated based on the current location of the vehicle 10 and the destination, the vehicle 10 may be expected to travel to the destination along the driving route. Therefore, the vehicle 10 may be configured to determine an expected driving region based on the driving route of the navigation system 220. In other words, the vehicle 10 may be configured to predict a region that includes the driving route as a driving region. Meanwhile, the driving route of the vehicle 10 may be reset during driving. The vehicle 10 may be configured to determine whether the driving route is reset, in operation 614, and when a driving route is reset (“Yes” in operation 614), the vehicle 10 may again be configured to predict a driving region based on the reset driving route, in operation 613.

According to another exemplary embodiment of predicting a driving region, the vehicle 10 may be configured to determine an expected driving region based on distances of the vehicle 10 to the various regions. In other words, as shown in FIG. 8, the vehicle 10 may be configured to calculate distances from the vehicle 10 to each of the regions adjacent to a current driving region of the vehicle 10, and predict a region that is within a predetermined distance from the vehicle 10, as an expected driving region.

According to another exemplary embodiment of predicting a driving region, the vehicle 10 may be configured to predict a driving region based on a previous traveling route of the vehicle 10. As shown in FIG. 17, the vehicle 10 may be configured to collect driving information of the vehicle 10 during driving, in operation 621. In particular, the vehicle 10 may be configured to continuously collect driving information while the vehicle is being driven. Additionally, after collecting driving information, the vehicle 10 may be configured to delete or remove the collected driving information when a predetermined condition is satisfied. The vehicle 10 may be configured to predict a destination of the vehicle 10 based on the collected driving information of the vehicle 10, in operation 622. For example, the vehicle 10 may be configured to predict a destination based on locations stored in the navigation system 220 of the vehicle 10, locations to which the vehicle 10 has traveled to a predetermined number of times, or the latest trajectories of the vehicle 10.

The vehicle 10 may further be configured to determine whether the predicted destination is located within the current driving region of the vehicle 10, in operation 623. When the vehicle 10 determines that the predicted destination is beyond or outside of the current driving region of the vehicle 10 (“No” in operation 623), the vehicle 10 may be configured to predict a region of the predicted destination, as a driving region, in operation 624.

Referring to FIGS. 1, 3, 6, and 15, the vehicle 10 may be configured to update regulations information, in operation 520. The vehicle 10 may be configured to display a download progress of regulations information, as shown in FIG. 9, or display a window for receiving a user's confirmation to download regulations information, on the navigation system 220 or the cluster 41, as shown in FIG. 10 or 11. The vehicle 10 may be configured to determine whether regulations information of the expected driving region has been updated, and update the regulations information when the regulations information of the expected driving region has not been updated. Hereinafter, an exemplary embodiment of updating regulations information will be described with reference to FIG. 18.

Referring to FIG. 18, the vehicle 10 may be configured to transmit an inquiry to the regulations management apparatus 300 regarding whether regulations information of the expected driving region has been updated, in operation 701. In particular, the vehicle 10 may be configured to transmit an update history of regulations information to the regulations management apparatus 300. The regulations management apparatus 300 may be configured to receive the update history of regulations information, and determine whether regulations information of the expected driving region has been updated, in operation 703.

More specifically, the regulations management apparatus 300 may be configured to compare a version of regulations information or the latest download time of the regulations information included in the update history received from the vehicle 10, to a version of regulations information or a update time of the regulations information stored in the regulations information database 330, thus determining whether regulations information of the expected driving region has been updated. The regulations management apparatus 300 may then be configured to transmit the comparison results to the vehicle 10, in operation 705. When the results of the determination represent an update of the regulations information of the expected driving region, the vehicle 10 may be configured to prepare a download of the regulations information, in operation 707. For example, the vehicle 10 may be configured to secure storage space in which regulations information may be downloaded.

After preparing the download of regulation information, the vehicle 10 may be configured to request the regulations management apparatus 300 to transmit regulations information, operation 709. Then, the regulations management apparatus 300 may be configured to extract the changed or updated regulation items, in operation 711, and transmit the extracted regulation items to the vehicle 10, in operation 713. Accordingly, when only changed regulation items are extracted and transmitted, it may be possible to minimize load due to transmission. The vehicle 10 may then be configured to update regulations information of the expected driving region based on the extracted regulation items received from the regulations management apparatus 300, in operation 715.

Meanwhile, in FIG. 18, an example in which the regulations management apparatus 300 determines whether regulations information has been updated is shown, however, the vehicle 10 may be configured to determine whether regulations information has been updated. In particular, the regulations management apparatus 300 may be configured to transmit an update history to the vehicle 10.

Referring to FIGS. 1, 6, and 15, the vehicle 10 may be configured to determine whether the vehicle 10 enters an expected driving region, in operation 530. The vehicle 10 may then be configured to determine a current location based on location information received from the navigation system 220 to determine whether a driving region of the vehicle 10 has changed.

When it is determined that the vehicle 10 enters the expected driving region, the vehicle 10 may be configured to operated based on the updated regulations information, in operation 540. For example, the components of the vehicle 10, such as “lamps”, “idling”, “DMB”, etc., may be operated to comply with the updated regulations information. When the vehicle 10 requires an installation of software to comply with the regulations, like “hacking prevention” or “accident notification”, software may be updated according to the regulations. Further, additional software may be installed which is included in the regulations information. When the vehicle 10 enters the expected driving region, the regulations information of the expected driving region may be displayed. In particular, changed regulation items may be selectively displayed, as shown in FIG. 12.

According to the vehicle and the control method thereof as described above, it may be possible to control the vehicle to effectively respond to updated regulations. In addition, according to the vehicle and the control method thereof as described above, it may be possible to prevent excessive responses to regulations.

Although a few exemplary embodiments of the present disclosure have been shown and described, it would be appreciated by those skilled in the art that changes may be made in these exemplary embodiments without departing from the principles and spirit of the disclosure, the scope of which is defined in the claims and their equivalents.

What is claimed is:

1. A vehicle, comprising:
a communication unit configured to communicate with a regulations management apparatus that manages regulations information for individual regions;
a navigation system configured to receive location information of the vehicle and to display a location of the vehicle on a map output on a display; and
a controller configured to predict an expected driving region of the vehicle based on the location information of the vehicle and to download regulations information of the expected driving region from the regulations management apparatus when regulations information of the expected driving region has been updated.

2. The vehicle according to claim 1, wherein the regions are classified according to administrative districts or the identity of regulations information.

3. The vehicle according to claim 1, wherein the regulations information includes at least one selected from the group consisting of: a required regulation item and a recommended regulation item when driving the vehicle.

4. The vehicle according to claim 3, wherein the controller is configured to download the regulations information for each regulation item.

5. The vehicle according to claim 1, wherein the controller is configured to monitor whether the vehicle enters the expected driving region and manage the driving of the vehicle according to the downloaded regulations information when the vehicle enters the expected driving region.

6. The vehicle according to claim 5, wherein the controller is configured to adjust settings of the vehicle or install software in the vehicle based on the downloaded regulations information.

7. The vehicle according to claim 1, wherein the navigation system includes on which a changed item of the regulations information is displayed when the vehicle enters the expected driving region.

8. The vehicle according to claim 1, wherein the controller is configured to determine the expected driving region based on a driving history of the vehicle.

9. The vehicle according to claim 1, wherein the controller is configured to determine, as the expected driving region, a region that is within a predetermined distance from the vehicle among one or more regions adjacent to a current driving region of the vehicle.

10. The vehicle according to claim 1, wherein the controller is configured to determine the expected driving region based on a driving route toward a destination determined by the navigation system.

11. The vehicle according to claim 10, wherein the controller is configured to determine at least one region included in the driving route as the expected driving region.

12. The vehicle according to claim 1, wherein the controller is configured to manage an update history to determine whether the regulations information has been updated.

13. The vehicle according to claim 12, wherein the update history includes at least one selected from the group consisting of: a version of regulations information and an update time of regulations information for each region.

14. The vehicle according to claim 1, wherein the regulations management apparatus is a telematics server.

15. A control method of a vehicle, the vehicle communicating with a regulations management apparatus that manages regulations information for individual regions, comprising:
predicting, by a controller, an expected driving region based on location information of the vehicle; and
downloading, by the controller, regulations information regarding the expected driving region from the regulations management apparatus, when regulations information of the expected driving region has been updated.

16. The control method according to claim 15, further comprising:
managing, by the controller, driving of the vehicle based on the downloaded regulations information, when the vehicle enters the expected driving region.

17. The control method according to claim 16, wherein the managing of the driving of the vehicle includes installing, by the controller, software based on the downloaded regulations information.

18. The control method according to claim 16, wherein the managing of the driving of the vehicle includes changing, by the controller, settings of the vehicle based on the downloaded regulations information.

19. The control method according to claim 16, wherein the managing of the driving of the vehicle includes displaying, by the controller, a changed item of the regulations information when the vehicle enters the expected driving region.

20. The control method according to claim 15, wherein the predicting of the expected driving region includes determining, by the controller, the expected driving region based on a driving history of the vehicle.

21. The control method according to claim 15, wherein the predicting of the expected driving region includes determining, by the controller, as the expected driving region, a region that is within a predetermined distance from the vehicle among one or more regions adjacent to a current driving region of the vehicle.

22. The control method according to claim 15, wherein the predicting of the expected driving region comprises:
detecting, by the controller, a driving route toward a destination using a navigation system; and
determining, by the controller, the expected driving region based on the driving route.

23. The control method according to claim 15, wherein the downloading of the regulations information of the expected driving region comprises:
downloading, by the controller, an updated item of the regulations information from the regulations management apparatus;
updating, by the controller, regulations information of the vehicle based on the downloaded item; and
storing, by the controller, a history of the updated regulations information in the vehicle.

24. A non-transitory computer readable medium containing program instructions executed by a controller within a vehicle that communicates with a regulations management apparatus that manages regulations information for individual regions, the computer readable medium comprising:
program instructions that predict an expected driving region based on location information of the vehicle; and
program instructions that download regulations information regarding the expected driving region from the regulations management apparatus, when regulations information of the expected driving region has been updated.

25. The non-transitory computer readable medium of claim 24, further comprising:
program instructions that manage driving of the vehicle based on the downloaded regulations information, when the vehicle enters the expected driving region.
